(19) United States
(12) Patent Application Publication
(10) Pub. No.: US 2018/0195414 A1
(43) Pub. Date: Jul. 12, 2018

(54) EXHAUST-STEAM CASING FOR A STEAM TURBINE AND ASSEMBLY SYSTEM

(71) Applicant: Siemens Aktiengesellschaft, Munich (DE)

(72) Inventors: Rüdiger Backasch, Görlitz (DE); Mario Rolle, Neißeaue (DE); Paramdeep Singh, Delhi (IN)

(73) Assignee: Siemens Aktiengesellschaft, Munich (DE)

(21) Appl. No.: 15/742,167

(22) PCT Filed: May 19, 2016
(86) PCT No.: PCT/EP2016/061291

§ 371 Date: Jan. 5, 2018

(30) Foreign Application Priority Data
Jul. 15, 2015 (DE) 10 2015 213 257.9

(51) Int. Cl. F01D 25/24; F01D 25/28; F01D 25/30

(52) U.S. Cl. CPC F01D 25/243; F01D 25/28; F05D 2230/50; F05D 2220/31; F01D 25/30

(57) ABSTRACT

An exhaust-steam casing for a turbine, the exhaust-steam casing being designed to discharge the exhaust steam of the turbine in a radial direction with respect to a longitudinal axis of a rotor shaft of the turbine and having an upper exhaust-steam casing part and at least one side exhaust-steam casing part. The upper exhaust-steam casing part and/or the side exhaust-steam casing part have a lower exhaust-steam casing part connection surface for connecting the exhaust-steam casing to a lower exhaust-steam casing part. A turbine frame, a turbine casing and an assembly system for a turbine has an exhaust-steam casing.

### CROSS REFERENCE TO RELATED APPLICATIONS

This application is the US National Stage of International Application No. PCT/EP2016/061291 filed May 19, 2016, and claims the benefit thereof. The International Application claims the benefit of German Application No. DE 102015213257.9 filed Jul. 15, 2015. All of the applications are incorporated by reference herein in their entirety.

### FIELD OF INVENTION

The present invention relates to an exhaust-steam casing for a turbine, to a turbine framework and to a turbine casing. The invention also relates to an assembly system for a turbine.

### BACKGROUND OF INVENTION

Turbines are flow machines that are designed for converting internal energy of a flowing fluid into mechanical energy. Known turbines have a turbine shaft, which is rotatably mounted in a turbine casing and has a multiplicity of moving blades. Turbines have in the turbine casing moving blades that are designed for deflecting the flowing fluid in order to achieve a more efficient incident flow on the moving blades. This incident flow on the moving blades has the effect of producing a torque, which sets the turbine shaft in rotation. This mechanical energy can be converted into electrical energy, for example by way of a generator.

Turbines are often of a large overall size, since they are used for generating great amounts of mechanical energy, for example in power plants. Large turbines can therefore only be transported with great effort and at great cost.

Instead of transporting a complete turbine, it is known after successful test operation and approval by quality control to disassemble a turbine into small units, to transport the small units to the place of use and to reassemble the turbine at the place of use. During the reassembly, individual components are often joined together by welding. This has the disadvantage that a large number of small units have to be transported and provided at the place of use. This likewise gives rise to great logistical costs and a great effort in providing the small units ready to assemble at the place of use. Furthermore, assembly of the small units at the place of use is very laborious and has the disadvantage in particular that laborious aligning and joining processes are required. This likewise gives rise to great costs.

### SUMMARY OF INVENTION

An object of the present invention is therefore to provide an exhaust-steam casing for a turbine, a turbine framework, a turbine casing and an assembly system for building a turbine that do not have or at least partially overcome the disadvantages of the prior art. The object of the present invention is in particular to provide an exhaust-steam casing for a turbine, a turbine framework, a turbine casing and an assembly system for a turbine that can be transported easily and at low cost and can be assembled easily, at low cost and reliably. In particular, a turbine is intended to be designed in such a way that it can be easily transported without great effort in technical terms.

This object is achieved according to the invention by the patent claims. In particular, the object is achieved by an exhaust-steam casing, a turbine framework, a turbine casing and also an assembly system of the independent claims. Further features and details of the invention are provided by the dependent claims, the description and the drawings. It goes without saying that features and details that are described in connection with the exhaust-steam casing according to the invention of a turbine also apply in connection with the turbine framework according to the invention, the turbine casing according to the invention and the assembly system according to the invention for building a turbine, and conversely in each case, so that reference is or can always be made from one to the other with respect to the disclosure in respect of the individual aspects of the invention.

According to a first aspect of the invention, the object is achieved according to the invention by an exhaust-steam casing for a turbine, the exhaust-steam casing being designed for discharging the exhaust steam of the turbine in a radial direction with respect to a longitudinal axis of a rotor shaft of the turbine. The exhaust-steam casing has an upper exhaust-steam casing part and at least one side exhaust-steam casing part. Advantageously, the exhaust-steam casing has two side exhaust-steam casing parts. The upper exhaust-steam casing part and/or the side exhaust-steam casing part have a lower exhaust-steam casing part connection surface for connecting the exhaust-steam casing to a lower exhaust-steam casing part.

The exhaust-steam casing is designed as a radial exhaust-steam casing and has a sealed interior space, which is designed for discharging the exhaust steam out of the turbine casing. Therefore, the radial exhaust-steam casing has a relatively great space requirement. The exhaust-steam casing is designed to be arranged fluid-tightly on the turbine casing, in order that the exhaust steam cannot escape at interfaces between the turbine casing and the exhaust-steam casing.

The upper exhaust-steam casing part can be arranged radially at a distance from a rotor shaft of the turbine above said shaft on the turbine casing; the side exhaust-steam casing parts can be arranged radially at a distance from the rotor shaft on opposite sides of said shaft. The side exhaust-steam casing parts are advantageously arranged or can be arranged in a detachable and sealing manner on the upper exhaust-steam casing part. Alternatively, the upper exhaust-steam casing part and the side exhaust-steam casing parts may be connected to one another in an undetachable manner, for example by means of a weld.

The upper exhaust-steam casing part and/or the side exhaust-steam casing part have a lower exhaust-steam casing part connection surface for connecting, i.e. fastening, the exhaust-steam casing to a lower exhaust-steam casing part. Advantageously, both the upper exhaust-steam casing part and the side exhaust-steam casing part or the side exhaust-steam casing parts have such a lower exhaust-steam casing part connection surface. A lower exhaust-steam casing part connection surface is an interface that is designed for connecting or fastening the exhaust-steam casing to a lower exhaust-steam casing part in a sealing manner. Particularly, the lower exhaust-steam casing part connection surface is designed in such a way that it is easily possible for the exhaust-steam casing and the lower exhaust-steam casing part to be joined together correctly and/or that it can be easily seen if the exhaust-steam casing and the lower exhaust-steam casing part are joined together incorrectly.

In functional terms, the lower exhaust-steam casing part is a part of an exhaust-steam casing, since it serves together with the upper exhaust-steam casing part and the side exhaust-steam casing parts for discharging the exhaust steam of the turbine. The lower exhaust-steam casing part may in this case be designed for example as part of the exhaust-steam casing. A lower exhaust-steam casing part designed in such a way can be arranged on a turbine framework and detached from it again. Alternatively, the lower exhaust-steam casing part may be designed as part of the turbine framework. In this case, the exhaust-steam casing can be arranged on the lower exhaust-steam casing part of the turbine framework in a sealing manner and can be fixed in a detachable manner. The exhaust-steam casing is advantageously designed to be assembled as a complete unit on the turbine at the place of use. Alternatively, the exhaust-steam casing is designed in such a way as to be assembled piece by piece on the turbine at the place of use. It is in this case advantageous if the exhaust-steam casing is designed in such a way that first the side exhaust-steam casing parts and then the upper exhaust-steam casing part can be assembled on the turbine.

An exhaust-steam casing according to the invention has the advantage that it can be easily disassembled from a turbine for transport and can be transported by simple means. Furthermore, the exhaust-steam casing can be easily assembled again on the turbine, since it is only necessary to carry out an alignment of the exhaust-steam casing or the side exhaust-steam casing part and the upper exhaust-steam casing part in relation to the turbine. Laborious alignment and assembly or welding-on of a multiplicity of individual metal sheets on the turbine is consequently not required. Since the exhaust-steam casing generally represents the widest part of a turbine, after easy disassembly of such an exhaust-steam casing the turbine can be easily transported.

In an advantageous refinement of the invention, the exhaust-steam casing, advantageously the lower exhaust-steam casing part connection surface, has at least one exhaust-steam casing centering means, which is designed for aligning the exhaust-steam casing in a predefined position in relation to the lower exhaust-steam casing part. A centering means is for example a centering pin or a corresponding receptacle for a centering pin. An alternative or additional centering means is a centering strip, which advantageously has a bevel for bringing the exhaust-steam casing and the lower exhaust-steam casing part together more easily. The centering strip is advantageously designed to align the exhaust-steam casing and the lower exhaust-steam casing part in relation to one another at least in one direction when the exhaust-steam casing and the lower exhaust-steam casing part are brought together. By means of a number of such centering strips, an optimum alignment of the exhaust-steam casing and the lower exhaust-steam casing part can be achieved when they are brought together. It goes without saying that a centering means may also be arranged on the lower exhaust-steam casing part. A centering means has the advantage that correct assembly of the exhaust-steam casing on the lower exhaust-steam casing part by simple means is made much easier.

Advantageously, the upper exhaust-steam casing part and the side exhaust-steam casing part have an upper exhaust-steam casing part connection surface, the upper exhaust-steam casing part connection surface having an upper exhaust-steam casing part centering means, which is designed for aligning the upper exhaust-steam casing part in a predefined position in relation to the side exhaust-steam casing part. An upper exhaust-steam casing part connection surface is an interface that is designed for connecting the upper exhaust-steam casing part to the side exhaust-steam casing parts. Particularly, the upper exhaust-steam casing part connection surface is designed in such a way that it is easily possible for the upper exhaust-steam casing part and the side exhaust-steam casing part to be joined together correctly and/or that it can be easily seen if the upper exhaust-steam casing part and the side exhaust-steam casing part are joined together incorrectly. The exhaust-steam casing centering means makes it easier to align the upper exhaust-steam casing part with the side exhaust-steam casing parts. In the case of this advantageous embodiment of the invention, the upper exhaust-steam casing part and the side exhaust-steam casing part can be easily separated from one another and easily joined together again. This has the advantage that the upper exhaust-steam casing part and the side exhaust-steam casing part can be transported separately from one another and from the turbine. The exhaust-steam casing and the turbine can consequently be transported in smaller units. As a result, transport costs can be lowered further. The upper exhaust-steam casing part centering means has the advantage that the exhaust-steam casing can be easily put together, and consequently the turbine can be assembled quickly and at low cost, for example at a customer's premises.

It is advantageous that the exhaust-steam casing has a lower exhaust-steam casing part, which has a turbine casing connection surface for connecting the lower exhaust-steam casing part to a turbine casing and also has an exhaust-steam casing connection surface for connecting the upper exhaust-steam casing part and/or the side exhaust-steam casing part to the lower exhaust-steam casing part. A turbine casing connection surface is an interface between the exhaust-steam casing and the turbine casing. Particularly, the turbine casing connection surface is designed in such a way that it is easily possible for the exhaust-steam casing and the turbine casing to be joined together correctly and/or that it can be easily seen if the exhaust-steam casing and the turbine casing are joined together incorrectly. Advantageously, the exhaust-steam casing has corresponding centering means for aligning with the turbine casing. This advantageous embodiment of the invention has the advantage that the lower exhaust-steam casing part, the side exhaust-steam casing parts and the upper exhaust-steam casing part can be transported separately from the rest of the turbine. Consequently, the rest of the turbine has a lower overall weight and in particular a lower space requirement or a smaller width. In this way, especially the transport costs of the turbine, i.e. the rest of the turbine, can be reduced significantly.

In another embodiment of the invention, the lower exhaust-steam casing part has a turbine framework connection surface, which is designed for connecting the lower exhaust-steam casing part to a turbine framework. A turbine framework connection surface is an interface between the lower exhaust-steam casing part and the turbine framework. Particularly, the turbine framework connection surface is designed in such a way that it is easily possible for the exhaust-steam casing and the turbine framework to be joined together correctly and/or that it can be easily seen if the exhaust-steam casing and the turbine framework are joined together incorrectly. Advantageously, the exhaust-steam casing has a corresponding centering means for aligning with the turbine framework. A turbine framework connection surface has the advantage that the lower exhaust-steam casing part can be arranged or can be fastened on the turbine framework easily and by simple means and at low cost. For transport, the lower exhaust-steam casing part can thus be easily removed from the turbine framework and joined together again correspondingly easily after transport. The individual parts can be transported more quickly and at lower cost than the joined-together unit.

It is advantageous that the lower exhaust-steam casing part connection surface and/or the upper exhaust-steam casing part connection surface and/or the exhaust-steam casing connection surface and/or the turbine framework connection surface are designed as (a) flange(s). A flange has the advantage that alignment and fastening of two components or subassemblies is easily possible. Consequently, the flange allows the components or subassemblies to be easily connected to one another in a force-fitting or material-bonded manner, for example can be clamped or can be welded.

Also, the lower exhaust-steam casing part connection surface and/or the upper exhaust-steam casing part connection surface and/or the exhaust-steam casing connection surface and/or the turbine framework connection surface have at least one lead-through for leading through a connecting bolt or a connecting screw. This has the advantage that two components or two subassemblies can be easily screwed to one another.

According to a second aspect of the invention, the object is achieved according to the invention by a turbine framework for a turbine, having a turbine frame with a turbine casing mounting and at least two rotor shaft bearing mountings. The turbine framework has a lower exhaust-steam casing part, which is fixed, in particular welded, on the turbine framework. The lower exhaust-steam casing part has an exhaust-steam casing connection surface for connecting an exhaust-steam casing according to the invention.

A turbine framework is a basic unit of a turbine, on which the further components of the turbine, such as for example the turbine casing, the rotor shaft bearings and the exhaust-steam casing, can be arranged. A basic unit of the turbine framework is the turbine frame. Arranged on the turbine frame is a turbine casing mounting, which is advantageously designed for supporting the turbine casing. Advantageously, the turbine casing mounting is additionally or alternatively designed for fixing the turbine casing on the turbine framework. Also arranged on the turbine frame are two rotor shaft bearing mountings, which are designed for example as placing surfaces for rotor shaft bearing blocks or as a lower part of a rotor shaft bearing block. The rotor shaft bearing mountings advantageously have a centering device, which makes alignment of the rotor shaft bearings in relation to the turbine framework easier. Advantageously, the rotor shaft bearing mountings are designed in such a way that the rotor shaft bearings or rotor shaft bearing blocks can be fixed on the turbine framework. The rotor shaft bearing mountings are advantageously at a distance from one another in order to ensure more secure mounting of the rotor shaft.

The turbine framework according to the invention has a lower exhaust-steam casing part, on which an exhaust-steam casing according to the invention that does not have a lower exhaust-steam casing part can be arranged and can be detachably fixed.

A turbine framework according to the invention has the advantage that it can be easily transported, since it has a much smaller setting-down area than a completely assembled turbine with exhaust-steam casing. The turbine casing with the rotor shaft may already be assembled on the turbine framework for transport. This has the advantage that fewer parts have to be assembled at the place of use of the turbine and as a result an assembly risk, that is to say a risk that parts are not correctly assembled, is reduced considerably. Furthermore, because of the interfaces that are present, the turbine framework can be assembled easily and by simple means with the further components of the turbine. In particular, an upper exhaust-steam casing part according to the invention can be arranged on the turbine framework and can be fixed on it easily and by simple means.

According to a third aspect of the invention, the object is achieved by a turbine casing for a turbine, having a lower turbine casing part and an upper turbine casing part for surrounding a portion of a rotor shaft of the turbine. The lower turbine casing part has a lower high-pressure casing part and a lower low-pressure casing part. The upper turbine casing part has an upper high-pressure casing part and an upper low-pressure casing part. The lower high-pressure casing part and/or the upper high-pressure casing part are designed as a cast part. Advantageously, the lower high-pressure casing part and the upper high-pressure casing part are designed as a cast part. The lower low-pressure casing part and/or the upper low-pressure casing part are designed as a sheet-metal part. Advantageously, the lower low-pressure casing part and the upper low-pressure casing part are designed as a sheet-metal part.

It is consequently advantageous that a high-pressure part of the turbine casing is designed as a cast part and a low-pressure part of the turbine casing is designed as a sheet-metal part.

Such a turbine casing has the advantage that it can be produced at lower cost, since a much smaller casting mold is required for producing the upper high-pressure casing part and the lower high-pressure casing part. A sheet-metal construction can likewise be produced at low cost and is sufficiently stable for the low-pressure range. Furthermore, the parts of the turbine casing can be transported separately from one another, so that as a result transport costs can be lowered.

Advantageously, the lower high-pressure casing part is welded to the lower low-pressure casing part and the upper high-pressure casing part is welded to the upper low-pressure casing part. Welding ensures in a reliable way a secure and liquid-tight connection of the components welded to one another.

According to a fourth aspect of the invention, the object is achieved by an assembly system for a turbine, having a turbine casing and a turbine framework with a turbine frame, at least one turbine casing mounting and at least two rotor shaft bearing mountings being arranged on the turbine frame, the assembly system having an exhaust-steam casing according to the invention.

Such an assembly system has in particular the advantage that it can be transported by simple means and at low cost and can be assembled at a place of use of the turbine by simple means and at low cost and reliably.

According to a fifth aspect of the invention, the object is achieved by an assembly system for a turbine, having a turbine casing, the assembly system having an exhaust-steam casing according to the invention without a lower exhaust-steam casing part and a turbine framework according to the invention, having a lower exhaust-steam casing part.

Such an assembly system has in particular the advantage that it can be transported by simple means and at low cost and can be assembled at a place of use of the turbine by simple means and at low cost and reliably.

It is advantageous if the assembly system has a turbine casing according to the invention. This has the advantage that the assembly system can be produced at lower cost, since a much smaller casting mold is required for producing the upper high-pressure casing part and the lower high-pressure casing part. A sheet-metal construction can likewise be produced at low cost and is sufficiently stable for the low-pressure range. Furthermore, the parts of the turbine casing can be transported separately from one another, so that as a result transport costs can be lowered.

### BRIEF DESCRIPTION OF THE DRAWINGS

The invention is now explained in more detail on the basis of exemplary embodiments with reference to the accompanying drawings, in which:

FIG. 1 shows a perspective view of a first embodiment of an exhaust-steam casing according to the invention;

FIG. 2 shows a perspective view of a turbine framework which is designed for assembling the exhaust-steam casing from FIG. 1;

FIG. 3 shows a perspective view of a first embodiment of an assembly system according to the invention;

FIG. 4 shows a perspective view of a turbine framework which is designed for assembling a second embodiment of an exhaust-steam casing according to the invention;

FIG. 5 shows a perspective view of a second embodiment of an assembly system according to the invention; and

FIG. 6 shows a perspective view of a lower turbine casing part according to the invention.

### DETAILED DESCRIPTION OF INVENTION

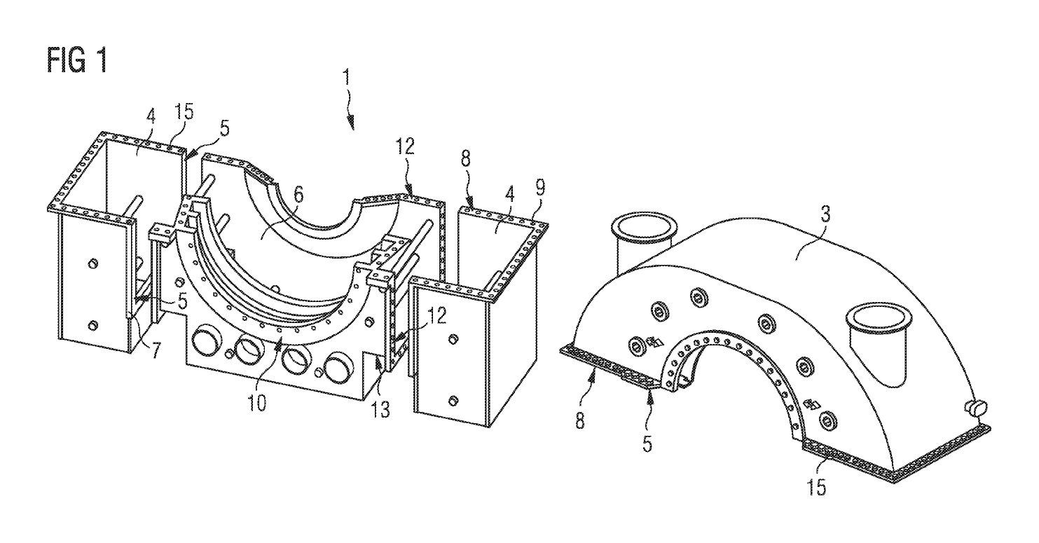

The exhaust-steam casing 1 represented in FIG. 1 has an upper exhaust-steam casing part 3 comprising a U-shaped basic body with two ends. The upper exhaust-steam casing part 3 has at each of the two ends an outer upper exhaust-steam casing part connection surface 8 for connecting to a side exhaust-steam casing part 4 and an inner lower exhaust-steam casing part connection surface 5 for connecting to a lower exhaust-steam casing part 6. The side exhaust-steam casing parts 4 correspondingly have in each case an upper exhaust-steam casing part connection surface 8 for connecting to the upper exhaust-steam casing part 3. The upper exhaust-steam casing part connection surfaces 8 are formed in each case on a flange and have a multiplicity of lead-throughs 15 for fastening means. Arranged on the side exhaust-steam casing parts 4 are upper exhaust-steam casing part centering means 9 for aligning the upper exhaust-steam casing part 3 with the side exhaust-steam casing parts 4, which means are designed for example as a centering pin or centering cone.

The side exhaust-steam casing parts 4 also have in each case a lower exhaust-steam casing part connection surface 5 for connecting to a lower exhaust-steam casing part 6. Arranged on the side exhaust-steam casing parts 4 are exhaust-steam casing centering means 7 for aligning the side exhaust-steam casing parts 4 with the lower exhaust-steam casing part 6, which means are designed for example as a centering pin or centering cone.

The lower exhaust-steam casing part 6 has exhaust-steam casing connection surfaces 12 for connecting to the upper exhaust-steam casing part 3 and the side casing parts 4. Furthermore, the lower exhaust-steam casing part 6 has turbine framework connection surfaces 13 for connecting to a turbine framework 14. Orthogonal to the exhaust-steam casing connection surfaces 12 and the turbine framework connection surfaces 13, the lower exhaust-steam casing part 6 has a turbine casing connection surface 10 for connecting to a turbine casing 11. Such an exhaust-steam casing can be easily transported and can be easily assembled on a turbine.

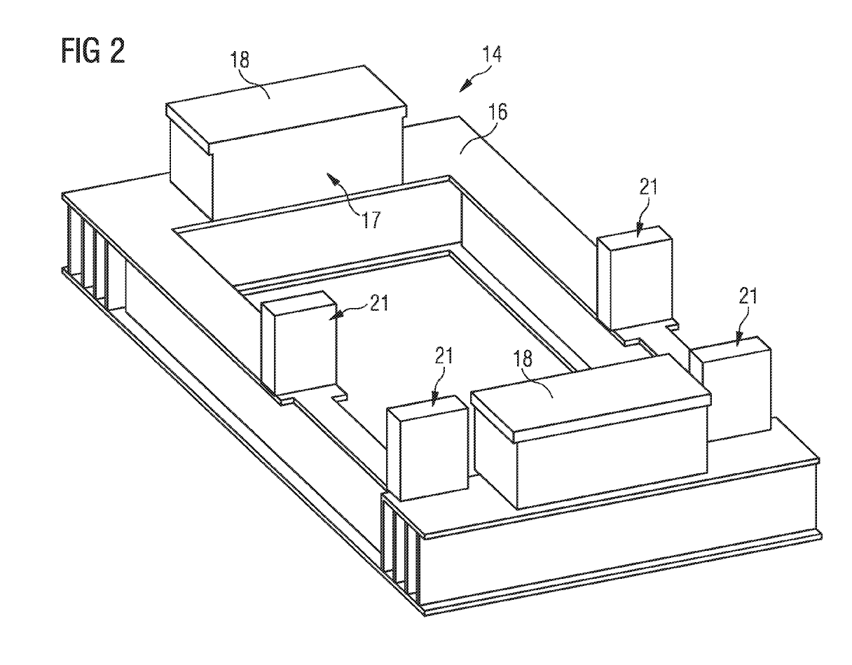

The turbine framework 14 represented in FIG. 2 is designed for connecting the exhaust-steam casing from FIG. 1. The turbine framework 14 has a turbine frame 16 with a rectangular base area. On the shorter sides of the turbine frame 16, rotor shaft bearing mountings 18 for receiving rotor shaft bearings 22 are arranged on the upper side. Arranged on the turbine frame 16 alongside a rotor shaft bearing mounting 18 are exhaust-steam casing attachment blocks 21, which are designed for arranging the exhaust-steam casing 1 from FIG. 1. Alongside the other rotor shaft bearing mounting 18, the turbine framework 14 has a turbine casing mounting 17 for receiving a turbine casing 11. In this example, the turbine casing mounting 17 is designed as a clearance in which the turbine casing 11 can be arranged.

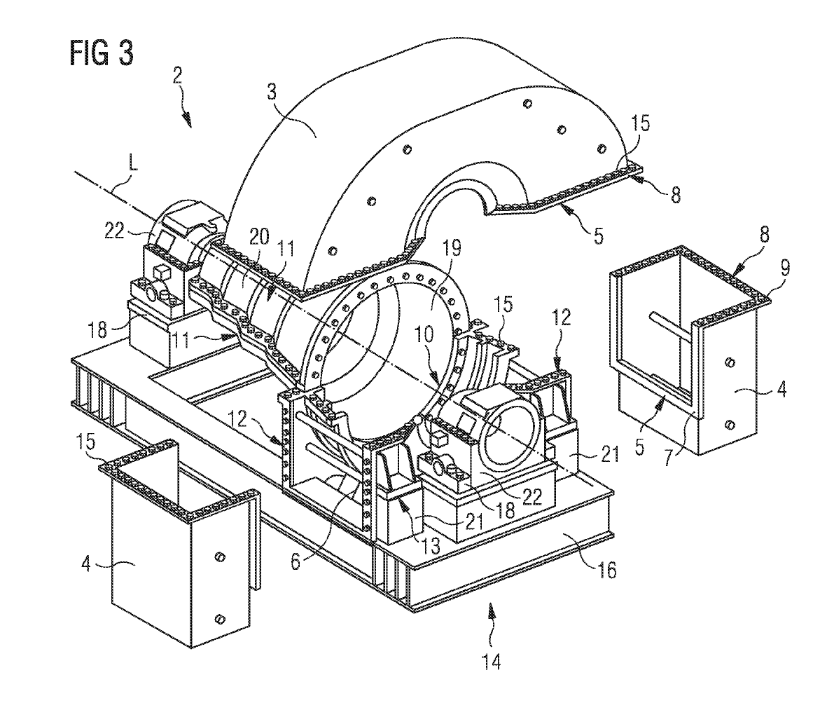

FIG. 3 shows a first embodiment of an assembly system according to the invention for a turbine 2. A rotor shaft with moving blades and stationary blades is not depicted. In this view, two rotor shaft bearings 22 are arranged on rotor shaft bearing mountings 18 of the turbine framework 14. A longitudinal axis L of the rotor shaft runs through the rotor shaft bearings 22. Arranged between the rotor shaft bearings 22 is a turbine casing 11 with a lower turbine casing part 19 and an upper turbine casing part 20. On an end face of the lower turbine casing part 19, a lower exhaust-steam casing part 6 is arranged and detachably fixed on it by means of fastening bolts that are not shown. In a non-assembled state, the exhaust-steam casing 1 shown in FIG. 1, with the upper exhaust-steam casing part 3 and two side exhaust-steam casing parts 4, is arranged around the turbine framework 14. The assembly system shown can consequently be transported for example in two units, a first unit comprising the turbine framework 14 with, arranged on it, the turbine casing 11 with stationary blades, the rotor shaft bearings 22, the lower exhaust-steam casing part 6 and the rotor shaft with moving blades. The second unit accordingly comprises the upper exhaust-steam casing part 3 with, arranged on it, the side exhaust-steam casing parts 4. Alternatively, the upper exhaust-steam casing part 3 and side exhaust-steam casing parts 4 can also be transported separately. The lower exhaust-steam casing part 6 can likewise be transported separately from the turbine framework 14.

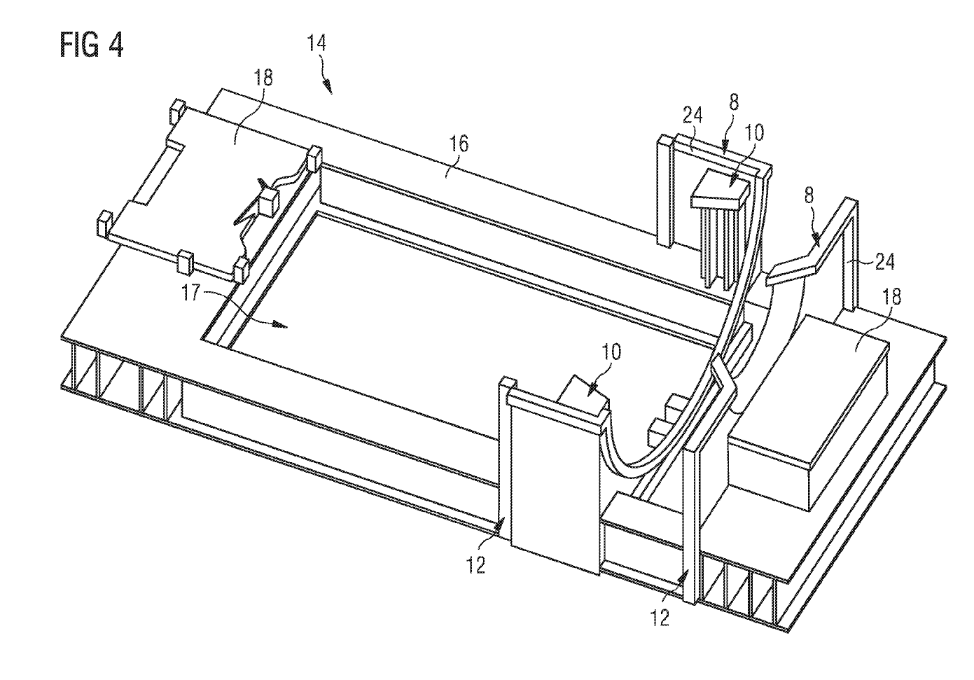

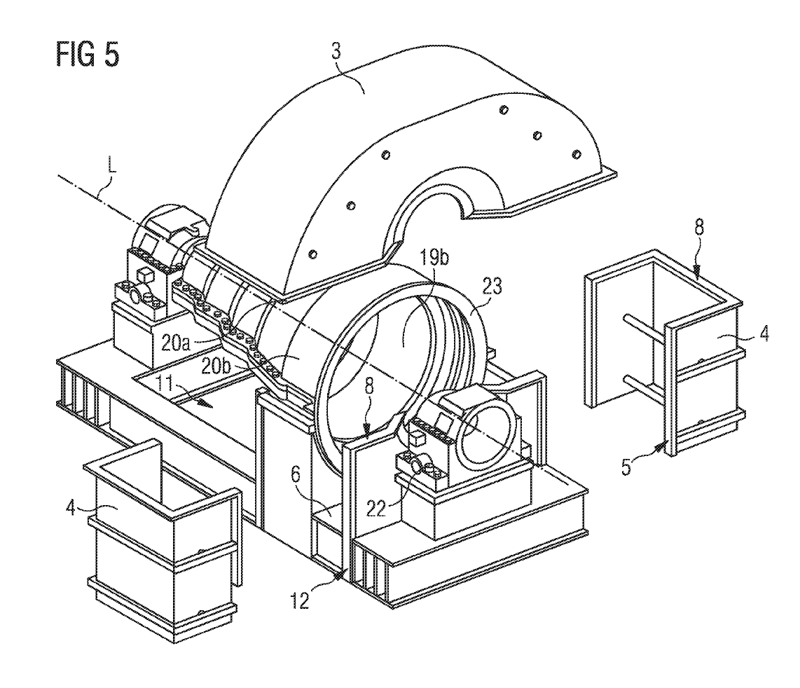

The turbine framework 14 shown in FIG. 4 is designed for assembling the second embodiment of an exhaust-steam casing according to the invention that is shown in FIG. 5. The turbine framework 14 has a turbine frame 16 with a rectangular base area, rotor shaft bearing mountings 18 being arranged on short sides. Between the rotor shaft bearing mountings 18, the turbine framework 14 has a turbine casing mounting 14. Arranged on the turbine frame 16 alongside a rotor shaft mounting 18 are metal sheets 24, on which upper exhaust-steam casing part connection surfaces 8, turbine casing connection surfaces 10 and exhaust-steam casing connection surfaces 12 are formed. The metal sheets 24 are arranged on the turbine framework 14 in such a way that together with the turbine frame 16 they are a substitute for a lower exhaust-steam casing part 6.

The second embodiment of an assembly system according to the invention, shown in FIG. 5, has the turbine framework 14 from FIG. 4, a rotor shaft bearing 22 being arranged on each of the rotor shaft bearing mountings 18 and a turbine casing 11 being arranged between the rotor shaft bearings 22. A longitudinal axis L of the rotor shaft runs through the rotor shaft bearings 22. The second embodiment of the assembly system according to the invention differs from the first embodiment of the assembly system according to the invention in the aspect that the lower exhaust-steam casing part 6 is formed integrally with the turbine framework 14. For sealing the turbine casing 11 with respect to the upper exhaust-steam casing part 3, the side exhaust-steam casing parts 4 and the turbine framework 14, a substantially annular sealing bellows 23 is arranged on the turbine casing 11. In the case of the second embodiment of the assembly system according to the invention, disassembly and separate transport of the lower exhaust-steam casing part 6 is not possible.

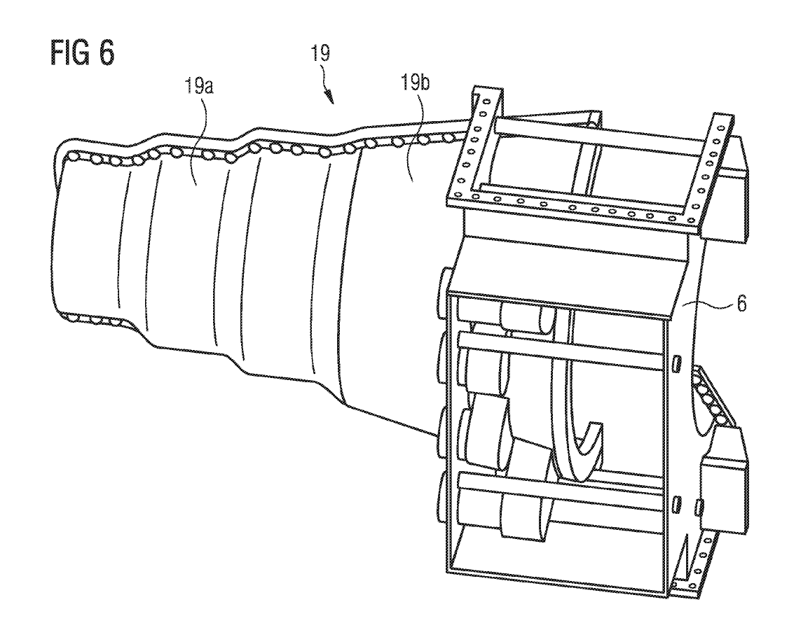

FIG. 6 shows a lower turbine casing part 19 of a turbine casing 11 according to the invention. The lower turbine casing part 19 has a lower high-pressure casing part 19a and a lower low-pressure casing part 19b, which are connected to one another by way of a weld. In this embodiment, a lower exhaust-steam casing part 6 is optionally formed as one part with the lower low-pressure casing part 19b or welded to it. The lower high-pressure casing part 19a is designed as a cast part and the lower low-pressure casing part 19b is designed as a sheet-metal construction. An upper turbine casing part 20 that is not depicted has an upper high-pressure casing part 20a and an upper low-pressure casing part 20b, which are advantageously welded to one another. The upper high-pressure casing part 20a is designed as a cast part and the upper low-pressure casing part 20b is designed as a sheet-metal construction.

1. An exhaust-steam casing for a turbine, the exhaust-steam casing being designed for discharging the exhaust steam of the turbine in a radial direction with respect to a longitudinal axis of a rotor shaft of the turbine, comprising:
an upper exhaust-steam casing part and at least one side exhaust-steam casing part,
wherein the upper exhaust-steam casing part and/or the side exhaust-steam casing part have a lower exhaust-steam casing part connection surface for connecting the exhaust-steam casing to a lower exhaust-steam casing part.

2. The exhaust-steam casing as claimed in claim 1,
wherein the exhaust-steam casing has at least one exhaust-steam casing centering means, which is designed for aligning the exhaust-steam casing in a predefined position in relation to the lower exhaust-steam casing part.

3. The exhaust-steam casing as claimed in claim 1,
wherein the upper exhaust-steam casing part and the side exhaust-steam casing part have an upper exhaust-steam casing part connection surface, the upper exhaust-steam casing part connection surface having an upper exhaust-steam casing part centering means, which is designed for aligning the upper exhaust-steam casing part in a predefined position in relation to the side exhaust-steam casing part.

4. The exhaust-steam casing as claimed claim 1,
wherein the exhaust-steam casing has a lower exhaust-steam casing part, which has a turbine casing connection surface for connecting the lower exhaust-steam casing part to a turbine casing and also has an exhaust-steam casing connection surface for connecting the upper exhaust-steam casing part and/or the side exhaust-steam casing part to the lower exhaust-steam casing part.

5. The exhaust-steam casing as claimed in claim 4,
wherein the lower exhaust-steam casing part has a turbine framework connection surface, which is designed for connecting the lower exhaust-steam casing part to a turbine framework.

6. The exhaust-steam casing as claimed in claim 1,
wherein the lower exhaust-steam casing part connection surface and/or the upper exhaust-steam casing part connection surface and/or the exhaust-steam casing connection surface and/or the turbine framework connection surface are designed as a flange.

7. The exhaust-steam casing as claimed in claim 6,
wherein the lower exhaust-steam casing part connection surface and/or the upper exhaust-steam casing part connection surface and/or the exhaust-steam casing connection surface and/or the turbine framework connection surface have at least one lead-through for leading through a connecting bolt.

8. A turbine framework for a turbine, comprising:
a turbine frame with a turbine casing mounting and at least two rotor shaft bearing mountings,
wherein the turbine framework has a lower exhaust-steam casing part, which is fixed on the turbine framework, the lower exhaust-steam casing part having an exhaust-steam casing connection surface for connecting an exhaust-steam casing as claimed in claim 1.

9. A turbine casing for a turbine, comprising:
a lower turbine casing part and an upper turbine casing part for surrounding a portion of a rotor shaft of the turbine,
wherein the lower turbine casing part has a lower high-pressure casing part and a lower low-pressure casing part and the upper turbine casing part has an upper high-pressure casing part and an upper low-pressure casing part, the lower high-pressure casing part and/or the upper high-pressure casing part being designed as a cast part and the lower low-pressure casing part and/or the upper low-pressure casing part being designed as a sheet-metal part.

10. The turbine casing as claimed in claim 9,
wherein the lower high-pressure casing part is welded to the lower low-pressure casing part and the upper high-pressure casing part is welded to the upper low-pressure casing part.

11. An assembly system for a turbine, comprising:
a turbine casing and a turbine framework with a turbine frame,
at least one turbine casing mounting and at least two rotor shaft bearing mountings being arranged on the turbine frame,
wherein the assembly system has an exhaust-steam casing as claimed in claim 1.

12. An assembly system for a turbine, comprising:
a turbine casing,
an exhaust-steam casing as claimed in claim 1, and
a turbine framework having a turbine frame with a turbine casing mounting and at least two rotor shaft bearing mountings, wherein the turbine framework has a lower exhaust-steam casing part, which is fixed on the turbine framework, the lower exhaust-steam casing part having an exhaust-steam casing connection surface for connecting the exhaust-steam casing.

13. The assembly system as claimed in claim 11, further comprising:
a turbine casing having a lower turbine casing part and an upper turbine casing part for surrounding a portion of a rotor shaft of the turbine,
wherein the lower turbine casing part has a lower high-pressure casing part and a lower low-pressure casing part and the upper turbine casing part has an upper high-pressure casing part and an upper low-pressure casing part, the lower high-pressure casing part and/or the upper high-pressure casing part being designed as a cast part and the lower low-pressure casing part and/or the upper low-pressure casing part being designed as a sheet-metal part.
